(19) United States
(12) Patent Application Publication
(10) Pub. No.: US 2012/0310749 A1
(43) Pub. Date: Dec. 6, 2012

(54) AD CREATIVE SELECTION BASED ON IMAGE CONTEXT

(76) Inventor: James R. Everingham, Santa Cruz, CA (US)

(21) Appl. No.: 13/151,110

(22) Filed: Jun. 1, 2011

(51) Int. Cl. G06Q 30/00

(52) U.S. Cl. 705/14.72

(57) ABSTRACT

Disclosed herein are systems and method for providing contextually relevant advertisements, and/or facilitating digital media advertising campaigns. For example, in one embodiment, there is provided a method of providing a contextually relevant advertisement, based on a digitally published image, the method comprising: (a) receiving the image from a publisher; (b) analyzing the image to obtain the context of the image; (c) matching an advertisement campaign to the image, based on the context of the image; and (d) providing the publisher with an ad creative that is mutually relevant to the context of the image and the advertisement campaign. In one embodiment, the systems and methods described are used in digital media and computer-implemented advertising. Various other alternative aspects and embodiments are further described herein.

### SUMMARY

Disclosed herein are systems and method for providing contextually relevant advertisements, and/or facilitating digital media advertising campaigns. For example, in one embodiment, there is provided a method of providing a contextually relevant advertisement, based on a digitally published image, the method comprising: (a) receiving the image from a publisher; (b) analyzing the image to obtain the context of the image; (c) matching an advertisement campaign to the image, based on the context of the image; and (d) providing the publisher with an ad creative that is mutually relevant to the context of the image and the advertisement campaign. In one embodiment, the systems and methods described are used in digital media and computer-implemented advertising. Various other alternative aspects and embodiments are further described herein.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level flowchart illustrating an embodiment of the present invention.

FIG. 2 a high-level flowchart illustrating an embodiment of implementing an image analysis protocol.

FIG. 3 is a flowchart illustrating a method in accordance with one embodiment.

FIG. 4 is a flowchart further illustrating a method in accordance with another embodiment.

FIG. 5 is a schematic drawing of a computer system used to implement the methods.

### DEFINITIONS

Prior to describing the present invention in detail, it is useful to provide definitions for key terms and concepts used herein.

Ad server: One or more computers, or equivalent systems, which maintains a database of creatives, delivers creative(s), and/or tracks advertisement(s), campaign(s), and/or campaign metric(s) independent of the platform where the advertisement is being displayed.

“Advertisement” or “ad”: One or more images, with or without associated text, to promote or display a product or service. Terms “advertisement” and “ad,” in the singular or plural, are used interchangeably.

Advertisement creative: A document, hyperlink, or thumbnail with advertisement, image, or any other content or material related to a product or service.

Advertising campaign: An outlined plan of an advertising project, including the goals and/or objectives of an advertiser, as well as the plan for creating, buying, and/or tracking of the advertising project.

“Campaign metrics” or “insertion order”: The details of an advertising campaign;

i.e., the terms of an agreement between the merchant and service provider. Campaign metrics include, but are not limited to, details such as: budget (e.g., daily, weekly, monthly, etc.); cost-per-click (CPC); cost-per-action (CPA); cost-per-day (CPD); cost-per-thousand (CPM) impressions of an advertisement; cost-per-sale (CPS); inventory (e.g., in/out of stock status); location (e.g., country, region, state, city, etc.); price (e.g., competitive bidding); duration of campaign; merchant promotions; time (e.g., hours per day, time of day, days per week, season, etc.); frequency of display; etc.

Contextual Advertising: a form of targeted advertising for advertisements and/or content appearing or displayed on digital media, such as websites or mobile browsers.

Contextual Information: data related to the contents and/or context of an image or content within the image; for example, but not limited to, a description, identification, index, or name of an image, or object, or scene, or person, or abstraction within the image.

Contextually Relevant Advertisement: An advertisement that is mutually relevant to the contents and/or context of an image and an advertising campaign.

Crowdsourcing: The process of delegating a task to one or more individuals, with or without compensation.

Document: Broadly interpreted to include any machine-readable and machine-storable work product (e.g., an email, a computer file, a combination of computer files, one or more computer files with embedded links to other files, web pages, digital image, etc.).

Image: a visual representation of an object, or scene, or person, or abstraction.

In-image advertising: a form of contextual advertising where specific images on a digital medium are matched with related advertisements, and the related advertisements are then provided within or around the specific image.

Proximate: Is intended to broadly mean “relatively adjacent, close, or near,” as would be understood by one of skill in the art. The term “proximate” should not be narrowly construed to require an absolute position or abutment. For example, “content displayed proximate to an image,” means “content displayed relatively near an image, but not necessarily abutting or within the image.” In another example, “content displayed proximate to an image,” means “content displayed on the same screen page or web page as the image.”

Publisher: party that owns, provides, and/or controls a digital content platform or medium; or third-party charged with providing, maintaining, and/or controlling a digital content platform or medium. Digital content platforms include websites, browser-based web applications, software applications, mobile device (e.g., phone or tablet) applications, TV widgets, and equivalents thereof.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims. Unless defined otherwise, all technical and scientific terms used herein have the same meaning as commonly understood by one of ordinary skill in the art to which this invention belongs.

### DETAILED DESCRIPTION

The present application is related to co-pending and co-owned U.S. patent application Ser. Nos. 12/902,066, filed on Oct. 11, 2010; 13/005,217, filed on Jan. 12, 2011; 13/005,226, filed Jan. 12, 2011; and 13/045,426, filed Mar. 10, 2011, the disclosures of which are all incorporated by reference herein in their entirety (with the exception of definitions that conflict with the above-provided definitions).

The present invention generally relates to digital media and computer-implemented advertising systems and methods. In digital media advertising, a common goal is to provide contextually relevant advertisements alongside text and/or images published on a digital platform. The commercial achievement of said goal, however, has been difficult. The present invention addresses said goal by presenting systems and methods that provide contextually relevant advertisements, and/or facilitate digital media advertising campaign.

For example, in one embodiment, there is provided a method of providing a contextually relevant advertisement, based on a digitally published image, the method comprising: (a) receiving the image from a publisher; (b) analyzing the image to obtain the context of the image; (c) matching an advertisement campaign to the image, based on the context of the image; and (d) providing the publisher with an ad creative that is mutually relevant to the context of the image and the advertisement campaign. Step (a) of said method may be performed by having the image pushed, pulled, or scraped from the publisher. Step (b) of said method may be performed by an image recognition engine and/or crowdsourcing. The method may further include: (e) providing the context of the image to one or more advertisers, such that the one or more advertisers can provide metrics for performing step (c). The ad creative may then be provided by the one or more advertisers. As such, the presented method creates a functional link between a digitally published image and the advertising needs/desires of one or more advertisers, as outlined by a pre-defined campaign metric. Such method may then be used in digital media and computer-implemented advertising. Various other alternative aspects and embodiments are further described below.

For instance, the following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

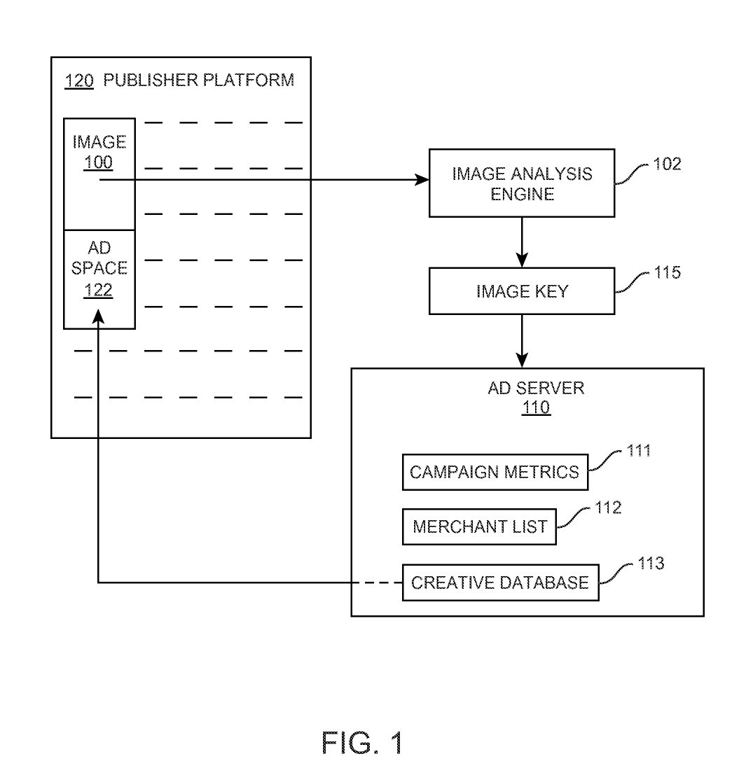

FIG. 1 is a high-level flowchart illustrating an embodiment of the present invention. As shown, an image 100 is pushed, pulled, or scraped from a publisher's platform 120, and submitted to an image analysis engine 102. Typically, image 100 is a digital image published on a platform such as: a website, a browser-based web application, a software application, a mobile device (e.g., phone or tablet) application, a TV widget, and equivalents thereof. Image 100 may be submitted to, identified to/by, or otherwise provided to image analysis engine 102 by any form of direct or indirect communication or link between the publisher's platform and the image analysis engine. For example, in one embodiment, an application program interface (API) is provided between platform 120 and image analysis engine 102. The image may be provided in one of many forms, such as a computer-readable document formatted to the specification of image analysis engine 102.

In order to provide a contextually relevant advertisement proximate to image 100 (e.g., in ad space 122), publishers and/or advertisers are interested in an automated technique for analyzing the image to obtain the context of the image, and matching the context of the image to one or more pre-defined advertising campaigns and/or campaign metrics. In the embodiment shown in FIG. 1, image analysis engine 102 is a means for providing the context of the image. For example, image analysis engine 102 may use one or more techniques to identify the context of image 100, and provide such context to one or more advertisers. In one embodiment, image analysis engine 102 identifies pre-tagged data associated with image 100. In another embodiment, image analysis engine 102 uses image recognition software or algorithms to identify the context of image 100. Image recognition algorithms and analysis programs are publicly available; see, for example, Wang et al., “Content-based image indexing and searching using Daubechies' wavelts,” Int J Digit Libr (1997) 1:311-328, which is herein incorporated by reference in its entirety. In still another embodiment, image analysis engine 102 may implement crowdsourcing protocols to identify the context of image 100.

In the embodiment shown in FIG. 1, the context of image 100 is presented to one or more advertisers in the form of a standardized image key 115, which is delivered to an ad server 110. Alternative communication and data transmission techniques are available. However, by providing a standardized image key, an automated process may be employed to link the context of the image to an advertising campaign and/or campaign metrics. For example, within ad server 110, image key 115 can be matched against campaign metrics 111, a merchant (or advertiser) list 112, and/or an ad creative database 113. In practice, image key 115 may include a matrix of image-related variables that correspond with a matrix of campaign variables, merchant variables, and/or ad creative variables maintained within ad server 110. As such, an ad creative can be automatically pulled from the ad server, based on image key 115. The ad creative is then forwarded to platform 120 for display in ad space 122

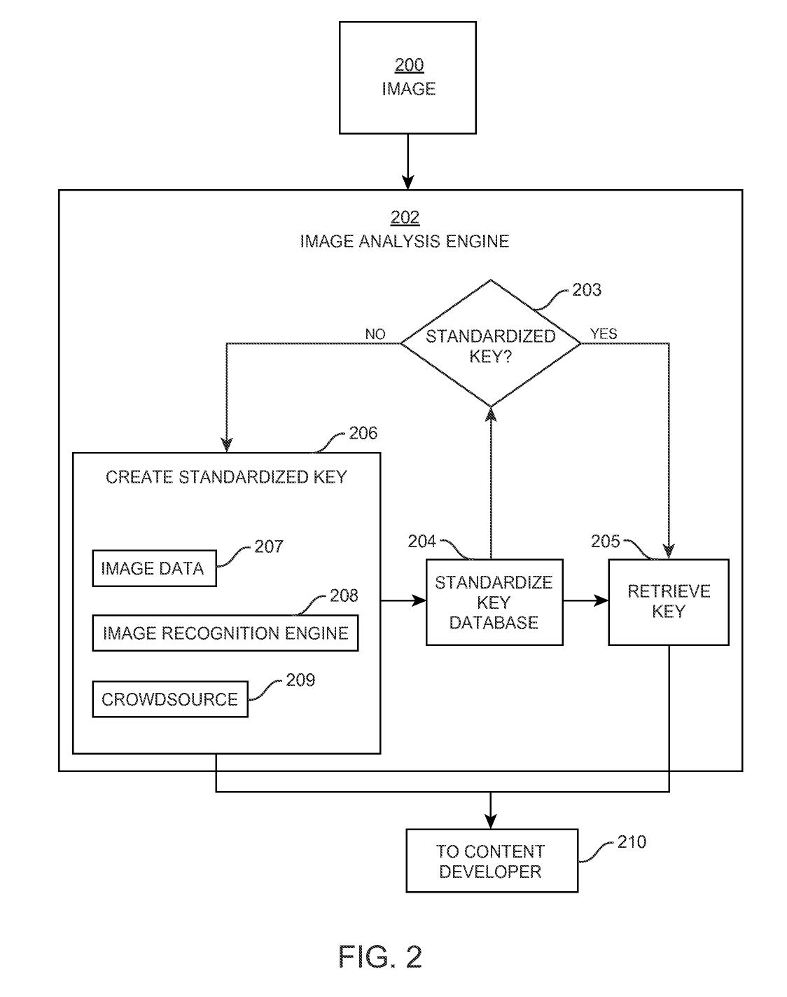

FIG. 2 is a high-level flowchart illustrating an embodiment of implementing an image analysis protocol. First, image 200 is submitted to, identified to/by, or otherwise provided to image analysis engine 202. Within image analysis engine 202, a protocol ensues whereby first the image is identified to determine whether a standardized key has already been assigned to the image, as shown in step 203. A standardized key database 204 can be called upon to identify the image. If a standardized key has already been assigned to image 200, the key is retrieved from database 204, as called for in step 205, and delivered to a content developer 210 (such as ad server 110).

If, in step 203, it is determined that a standardized key has not been assigned to image 200, then a standardized key is created, in step 206. The standardized key may be prepared in the form of a matrix of image-based variables. The matrix of image variables may include tags received from previous identified image data 207, image recognition engine 208, and our crowdsource 209. Once the standardized image key is created, it is provided to content developer 210 (such as ad server 110). In one embodiment, the standardized image key may be an Interactive Matrix Language (IML) key.

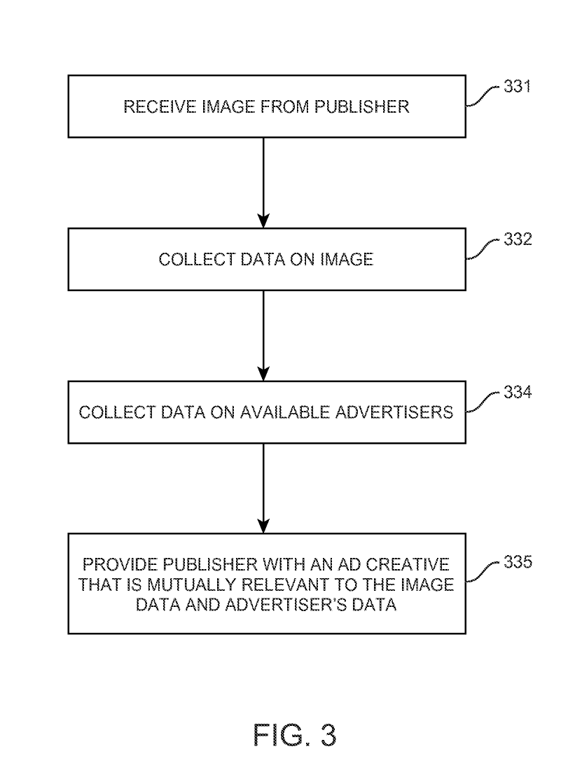

FIG. 3 is a flowchart illustrating a method in accordance with one embodiment presented herein. In step 331, an image is received from a publisher. The image may be received in various forms, and by various means. For example, the image may be pushed, pulled, or scraped from a publisher's platform. The image may be provided in one of many forms, such as a computer-readable document formatted to the specification of the receiving system. In step 332, data is collected on the image. The data may be collected by one or more means, such as: retrieval of metadata, image recognition software or algorithms, crowdsourcing, and any combinations or equivalents thereof. In step 334, data is collected on one or more available advertisers. The advertiser data may be drawn from advertising campaigns and/or campaign metrics maintained on an ad server. The advertiser data may include, without limitation, the objective(s), goal(s), and/or target audience(s) of an advertising campaign.

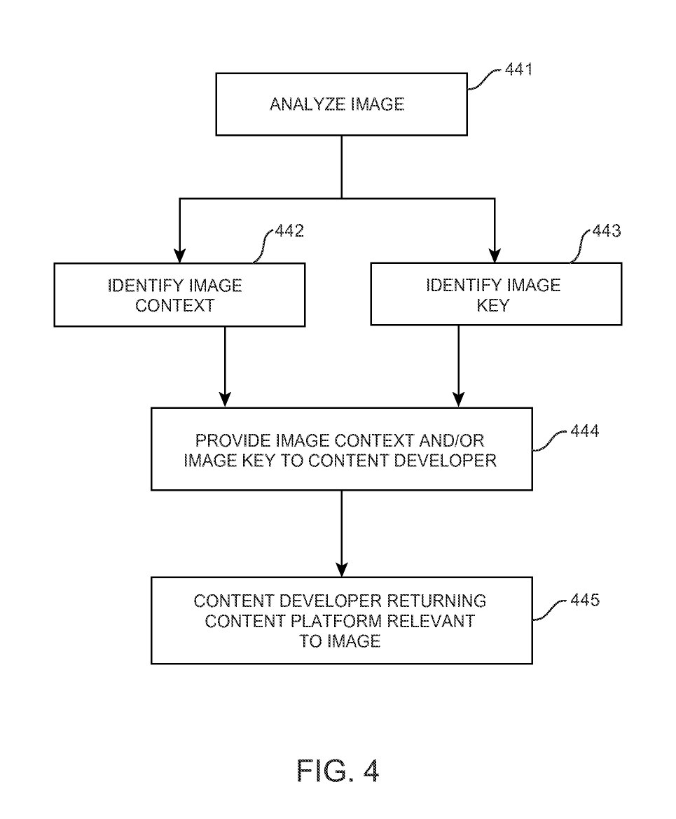

FIG. 4 is another flowchart illustrating a method, in accordance with one embodiment presented herein. In step 441, an image is analyzed. Image analysis may be performed by one or more means, including image recognition and/or crowdsourcing. One or more parallel processes may proceed from the image analysis. In step 442, the context of the image is identified. The context of the image may then be provided to a content developer in step 444. In step 443, an image key (e.g., a standardized image key) is identified (or prepared, or assigned). The image key may then be provided to a content developer in step 444. In step 445, the content developer returns a content platform relevant to the analyzed image. For example, a content developer (such as ad server 110) may match the image context and/or image key to one or more content platforms (e.g., an ad creative, a hyperlink, an interactive advertising interface, etc.). The content platform can then be returned (or forwarded) to a digital platform for publication proximate to the analyzed image. The method provided in FIG. 4 may thus be used to make digitally published images interactive.

### Additional Embodiments

In one embodiment, there is provided a method of providing a contextually relevant advertisement, based on a digitally published image, the method comprising: (a) receiving the image from a publisher; (b) collecting data on the image; (c) collecting data on one or more advertisers; and (d) based on the data collected in steps (b) and (c), providing the publisher with an ad creative that is mutually relevant to the image and the one or more advertisers. Step (a) may be performed by having the image pushed, pulled, or scraped from the publisher. Step (b) may be performed by an image recognition engine and/or crowdsourcing. Step (b) may include identifying the context of the image. Step (c) may include identifying campaign metrics for the one or more advertisers. The method may further include: (e) providing the context of the image to the one or more advertisers. The ad creative may be provided by the one or more advertisers.

In another embodiment, there is provided a method of facilitating a digital advertisement campaign, the method comprising: (a) identifying an image on a digital platform; (b) analyzing the image to identify the context of the image; (c) creating a standardized image key based on the context of the image; and (d) providing the standardized image key to one or more advertisers. Step (a) may be performed by having the image pushed, pulled, or scraped from the digital platform. Step (b) may be performed by an image recognition engine and/or crowdsourcing. Step (d) may be performed by submitting the standardized image key to an ad server, wherein the standardized image key is used to automatically match the image to a relevant ad creative based on pre-set campaign metrics. The standardize image key may include a matrix of image variables, and wherein the pre-set campaign metrics include a matrix of campaign variables that correspond to respective image variables. The method may further include: (e) pulling an ad creative from the ad server based on the standardized image key; and forwarding the ad creative to the digital platform.

In still another embodiment, there is provided a method of facilitating a digital advertisement campaign, the method comprising: (a) identifying an image on a digital platform; (b) analyzing the image to identify content-specific image data; (c) assigning a standardized image key to the image, wherein the standardized image key is based on a pre-defined image data matrix with variables that correspond to campaign metrics maintained by one or more advertisers on an ad server; (d) providing the standardized image key to the ad server, wherein the standardized image key is used to match the image to a relevant ad creative; (e) pulling the ad creative from the ad server; and (f) forwarding the ad creative to the digital platform. Step (b) may be performed by an image recognition engine and/or crowdsourcing.

In another embodiment, there is provided a method comprising: (a) steps for receiving the image from a publisher; (b) steps for analyzing the image to obtain the context of the image; (c) steps for matching an advertisement campaign to the image, based on the context of the image; and (d) steps for providing the publisher with an ad creative that is mutually relevant to the context of the image and the advertisement campaign. The method may further include: (e) steps for providing the context of the image to one or more advertisers, such that the one or more advertisers can provide metrics for performing steps (c).

In another embodiment, there is provided a method comprising: (a) steps for identifying an image on a digital platform; (b) steps for analyzing the image to identify the context of the image; (c) steps for creating a standardized image key based on the context of the image; and (d) steps for providing the standardized image key to one or more advertisers.

In still another embodiment, there is provided a method comprising: (a) steps for identifying an image on a digital platform; (b) steps for analyzing the image to identify content-specific image data; (c) steps for assigning a standardized image key to the image, wherein the standardized image key is based on a pre-defined image data matrix with variables that correspond to campaign metrics maintained by one or more advertisers on an ad server; (d) steps for providing the standardized image key to the ad server, wherein the standardized image key is used to match the image to a relevant ad creative; (e) steps for pulling the ad creative from the ad server; and (f) steps for forwarding the ad creative to the digital platform.

In yet another embodiment, there is provided a computer-based system, comprising: (a) means for receiving the image from a publisher; (b) means for analyzing the image to obtain the context of the image; (c) means for matching an advertisement campaign to the image, based on the context of the image; and (d) means for providing the publisher with an ad creative that is mutually relevant to the context of the image and the advertisement campaign. The system may further include: (e) means for providing the context of the image to one or more advertisers, such that the one or more advertisers can provide metrics for performing means for matching an advertisement campaign to the image.

In yet another embodiment, there is provided a computer-based system, comprising: (a) means for identifying an image on a digital platform; (b) means for analyzing the image to identify the context of the image; (c) means for creating a standardized image key based on the context of the image; and (d) means for providing the standardized image key to one or more advertisers.

In another embodiment, there is provided a computer-based system, comprising: (a) means for identifying an image on a digital platform; (b) means for analyzing the image to identify content-specific image data; (c) means for assigning a standardized image key to the image, wherein the standardized image key is based on a pre-defined image data matrix with variables that correspond to campaign metrics maintained by one or more advertisers on an ad server; (d) means for providing the standardized image key to the ad server, wherein the standardized image key is used to match the image to a relevant ad creative; (e) means for pulling the ad creative from the ad server; and (f) means for forwarding the ad creative to the digital platform.

In one embodiment, the systems and methods presented are used for contextual advertising; in-image advertising; or equivalent digital media advertising aims.

### Communication Between Parties Practicing the Present Invention

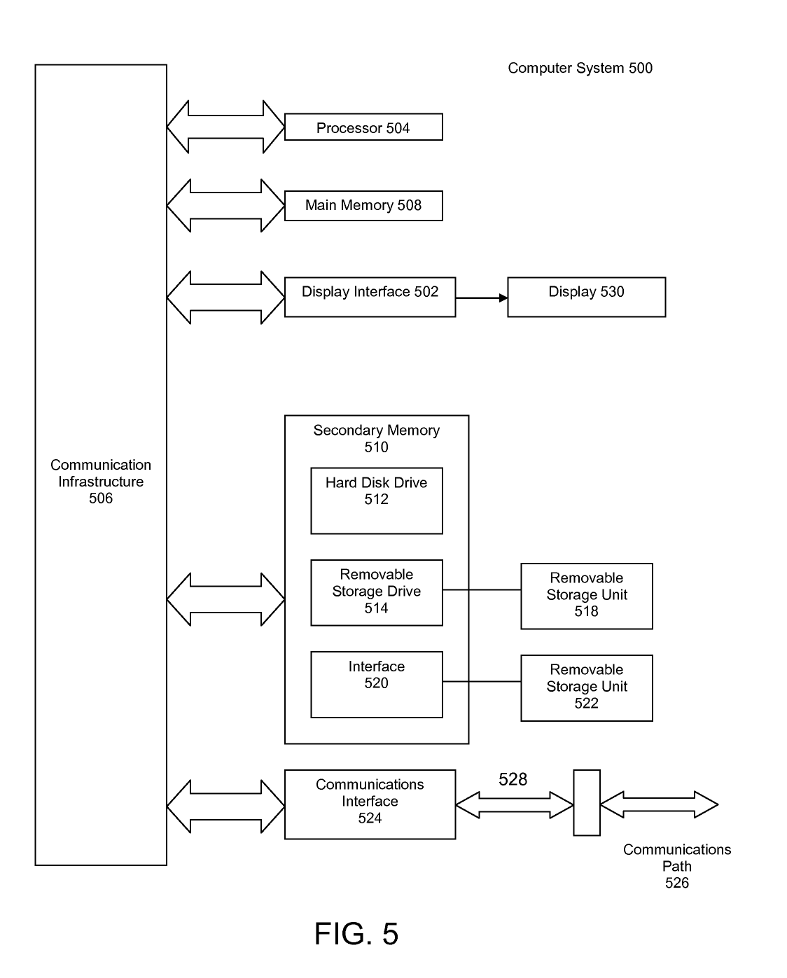

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 5, below.

### Computer Implementation

In one embodiment, the invention is directed toward one or more computer systems capable of carrying out the functionality described herein. For example, FIG. 5 is a schematic drawing of a computer system 500 used to implement the methods presented above. Computer system 500 includes one or more processors, such as processor 504. The processor 504 is connected to a communication infrastructure 506 (e.g., a communications bus, cross-over bar, or network). Computer system 500 can include a display interface 502 that forwards graphics, text, and other data from the communication infrastructure 506 (or from a frame buffer not shown) for display on a local or remote display unit 530.

Computer system 500 also includes a main memory 508, such as random access memory (RAM), and may also include a secondary memory 510. The secondary memory 510 may include, for example, a hard disk drive 512 and/or a removable storage drive 514, representing a floppy disk drive, a magnetic tape drive, an optical disk drive, flash memory device, etc. The removable storage drive 514 reads from and/or writes to a removable storage unit 518. Removable storage unit 518 represents a floppy disk, magnetic tape, optical disk, flash memory device, etc., which is read by and written to by removable storage drive 514. As will be appreciated, the removable storage unit 518 includes a computer usable storage medium having stored therein computer software, instructions, and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow computer software, instructions, and/or data to be transferred from the removable storage unit 522 to computer system 500.

Computer system 500 may also include a communications interface 524. Communications interface 524 allows computer software, instructions, and/or data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 514, removable storage units 518, 522, data transmitted via communications interface 524, and/or a hard disk installed in hard disk drive 512. These computer program products provide computer software, instructions, and/or data to computer system 500. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the presented methods. Accordingly, such computer programs represent controllers of the computer system 500. Where appropriate, the processor 504, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 500 using removable storage drive 514, interface 520, hard drive 512, communications interface 524, or equivalents thereof. The control logic (software), when executed by the processor 504, causes the processor 504 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) receive an image from a publisher; (b) collect data on the image; (c) collect data on one or more advertisers; (d) based on the data collected, provide the publisher with an ad creative that is mutually relevant to the image and the one or more advertisers; and/or (e) provide the context of the image to the one or more advertisers.

In another embodiment, there is provided a computer-readable storage medium, having instructions executable by at least one processing device that, when executed, cause the processing device to: (a) receive an image from a publisher; (b) analyze the image to obtain the context of the image; (c) match an advertisement campaign to the image, based on the context of the image; (d) provide the publisher with an ad creative that is mutually relevant to the context of the image and the advertisement campaign; and/or (e) provide the context of the image to one or more advertisers, such that the one or more advertisers can provide metrics for matching.

In still another embodiment, there is provided a computer-readable storage medium, having instructions executable by at least one processing device that, when executed, cause the processing device to: (a) identify an image on a digital platform; (b) analyze the image to identify the context of the image; (c) create a standardized image key based on the context of the image; (d) provide the standardized image key to one or more advertisers; and/or (e) pull an ad creative from the ad server based on the standardized image key; and forwarding the ad creative to the digital platform.

In still another embodiment, there is provided a computer-readable storage medium, having instructions executable by at least one processing device that, when executed, cause the processing device to: (a) identify an image on a digital platform; (b) analyze the image to identify content-specific image data; (c) assign a standardized image key to the image, wherein the standardized image key is based on a pre-defined image data matrix with variables that correspond to campaign metrics maintained by one or more advertisers on an ad server; (d) provide the standardized image key to the ad server, wherein the standardized image key is used to match the image to a relevant ad creative; (e) pull the ad creative from the ad server; and/or (f) forward the ad creative to the digital platform.

### Conclusion

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method of providing a contextually relevant advertisement, based on a digitally published image, the method comprising:
(a) receiving the image from a publisher;
(b) collecting data on the image;
(c) collecting data on one or more advertisers; and
(d) based on the data collected in steps (b) and (c), providing the publisher with an ad creative that is mutually relevant to the image and the one or more advertisers.

2. The method of claim 1, wherein step (a) is performed by having the image pushed, pulled, or scraped from the publisher.

3. The method of claim 1, wherein step (b) is performed by an image recognition engine.

4. The method of claim 1, wherein step (b) is performed by crowdsourcing.

5. The method of claim 1, wherein step (b) includes identifying the context of the image.

6. The method of claim 5, wherein step (c) includes identifying campaign metrics for the one or more advertisers.

7. The method of claim 6, further comprising:
providing the context of the image to the one or more advertisers.

8. The method of claim 7, wherein the ad creative is provided by the one or more advertisers.

9. A method of providing a contextually relevant advertisement, based on a digitally published image, the method comprising:
(a) receiving the image from a publisher;
(b) analyzing the image to obtain the context of the image;
(c) matching an advertisement campaign to the image, based on the context of the image; and
(d) providing the publisher with an ad creative that is mutually relevant to the context of the image and the advertisement campaign.

10. The method of claim 9, wherein step (a) is performed by having the image pushed, pulled, or scraped from the publisher.

11. The method of claim 9, wherein step (b) is performed by an image recognition engine.

12. The method of claim 9, wherein step (b) is performed by crowdsourcing.

13. The method of claim 9, further comprising:
providing the context of the image to one or more advertisers, such that the one or more advertisers can provide metrics for performing step (c).

14. The method of claim 13, wherein the ad creative is provided by the one or more advertisers.

15. A method of facilitating a digital advertisement campaign, the method comprising:
(a) identifying an image on a digital platform;
(b) analyzing the image to identify the context of the image;
(c) creating a standardized image key based on the context of the image; and
(d) providing the standardized image key to one or more advertisers.

16. The method of claim 15, wherein step (a) is performed by having the image pushed, pulled, or scraped from the digital platform.

17. The method of claim 15, wherein step (b) is performed by an image recognition engine.

18. The method of claim 15, wherein step (b) is performed by crowdsourcing.

19. The method of claim 15, wherein step (d) is performed by submitting the standardized image key to an ad server, wherein the standardized image key is used to automatically match the image to a relevant ad creative based on pre-set campaign metrics.

20. The method of claim 19, wherein the standardize image key includes a matrix of image variables, and wherein the pre-set campaign metrics include a matrix of campaign variables that correspond to respective image variables.

21. The method of claim 19, further comprising:
pulling an ad creative from the ad server based on the standardized image key; and
forwarding the ad creative to the digital platform.

22. A method of facilitating a digital advertisement campaign, the method comprising:
(a) identifying an image on a digital platform;
(b) analyzing the image to identify content-specific image data;
(c) assigning a standardized image key to the image, wherein the standardized image key is based on a pre-defined image data matrix with variables that correspond to campaign metrics maintained by one or more advertisers on an ad server;
(d) providing the standardized image key to the ad server, wherein the standardized image key is used to match the image to a relevant ad creative;
(e) pulling the ad creative from the ad server; and
(f) forwarding the ad creative to the digital platform.

23. The method of claim 22, wherein step (b) is performed by an image recognition engine.

24. The method of claim 22, wherein step (b) is performed by crowdsourcing.
